(19) United States
(12) Patent Application Publication
(10) Pub. No.: US 2023/0057325 A1
(43) Pub. Date: Feb. 23, 2023

(54) APPARATUS FOR IMPROVING DETECTION AND IDENTIFICATION BY NON-VISUAL SCANNING SYSTEM

(71) Applicant: Omer Salik, Hermosa Beach, CA (US)

(72) Inventor: Omer Salik, Hermosa Beach, CA (US)

(21) Appl. No.: 17/405,931

(22) Filed: Aug. 18, 2021

(51) Int. Cl. G01S 17/89; G01S 17/931; A41D 1/00

(52) U.S. Cl. CPC G01S 17/89; G01S 17/931; A41D 1/002

(57) ABSTRACT

Apparatus and method for providing improved detection and identification of objects (e.g. people, pets, bicycles or vehicles), by devices, such as autonomous vehicles, that rely on non-visible detection systems, such as lidar, for understanding their surrounding environment. Such objects having integrated or embedded materials of a predetermined shape or pattern that is readily detectable and identified by devices using such detection systems, such as autonomous vehicles. The predetermined shape or pattern is of a material, such as aluminum, that is more easily detectable by a non-visible detection system and allows the detection system to recognize and identify the type of object, even in challenging visibility conditions.

### FIELD OF THE INVENTION

The present disclosure relates generally to an apparatus for improving the detection of objects by systems and devices reliant on LIDAR sensors, including autonomous vehicles.

### BACKGROUND OF THE INVENTION

A self-driving car, also known as an autonomous vehicle (AV or auto) or driverless car is a vehicle that is capable of sensing its environment and moving safely with little or no human input. Self-driving cars combine a variety of sensors to perceive their surroundings, such as cameras, radar, lidar, sonar, GPS, odometry and inertial measurement units. Control systems interpret sensory information to identify navigation paths, signage, signals, and obstacles, such as vehicles, pedestrians, bicycles and signage.

There are different systems that help the self-driving car control the car, including the car navigation system, the location system, the electronic map, the map matching, the global path planning, the environment perception, the laser perception, the radar perception, the visual perception, the vehicle control, the perception of vehicle speed and direction, and the vehicle control method. One of the primary challenges facing autonomous vehicles is the analysis of sensory data to provide accurate detection of other vehicles, pedestrians and cyclists.

Modern self-driving cars generally use Bayesian simultaneous localization and mapping (SLAM) algorithms, which integrate data from multiple sensors and an off-line map into current location estimates and map updates. Waymo has developed a variant of SLAM with detection and tracking of other moving objects (DATMO), which also handles obstacles such as cars and pedestrians. Simpler systems may use roadside real-time locating system (RTLS) technologies to aid localization. Typical sensors include lidar (Light Detection and Ranging), stereo vision, GPS and IMU. Control systems on automated cars may use Sensor Fusion, which is an approach that integrates information from a variety of sensors on the car to produce a more consistent, accurate, and useful view of the environment. Weather conditions often impede the car sensors needed for autonomous vehicles to operate accurately and effectively. For example, heavy rainfall, hail, or snow could impede the car sensors.

Lidar is an acronym of “light detection and ranging” or “laser imaging, detection, and ranging”. Lidar sometimes is called 3-D laser scanning, a special combination of a 3-D scanning and laser scanning. Lidar is a method for determining ranges (variable distance) by targeting an object with a laser and measuring the time for the reflected light to return to the receiver. Lidar may also use interferometry to measure distance. Lidar can also be used to make digital 3-D representations of areas, due to differences in laser return times, and by varying laser wavelengths. Certain applications use chirped Lidar, wherein the laser emits continuously varying frequencies, to allow measurements of distance utilizing the frequency and phase of the laser. Autonomous vehicles may use lidar for obstacle detection and avoidance to navigate safely through environments.

Lidar systems play an important role in the safety of transportation systems. Many electronic systems which add to the driver assistance and vehicle safety such as Adaptive Cruise Control (ACC), Emergency Brake Assist, and Anti-lock Braking System (ABS) depend on the detection of a vehicle's environment to act autonomously or semi-autonomously. Lidar mapping and estimation achieve this.

Current lidar systems use rotating hexagonal mirrors which split the laser beam. The upper three beams are used for vehicle and obstacles ahead and the lower beams are used to detect lane markings and road features. The major advantage of using lidar is that the spatial structure is obtained and this data can be combined with other sensors such as radar to get a picture of the environment. However, a significant issue with lidar is the difficulty in reconstructing data in poor weather conditions. In heavy rain, for example, the light pulses emitted from the lidar system are partially reflected off of rain droplets which adds noise to the data, called ‘echoes’.

In May 2018, researchers from the Massachusetts Institute of Technology announced that they had built an automated car that can navigate unmapped roads. Researchers at their Computer Science and Artificial Intelligence Laboratory (CSAIL) have developed a new system, called MapLite, which allows self-driving cars to drive on roads that they have never been on before, without using 3D maps. The system combines the GPS position of the vehicle, a “sparse topological map” such as OpenStreetMap, (i.e. having 2D features of the roads only), and a series of sensors that observe the road conditions.

Individual vehicles can benefit from information obtained from other vehicles in the vicinity, especially information relating to traffic congestion and safety hazards. Vehicular communication systems use vehicles and roadside units as the communicating nodes in a peer-to-peer network, providing each other with information. Vehicle networking may be desirable due to difficulty with computer vision being able to recognize brake lights, turn signals, buses, and similar things. However, the usefulness of such systems would be diminished by the fact current cars are not equipped with them. They may also pose privacy concerns.

Accordingly, the current development of autonomous vehicles focuses on either increasing the ability of the vehicle to detect and analyze the environment without reliance on specialized map data, smart infrastructure or environmental markers or improving the connectivity between the autonomous vehicle and other computing devices. Both of these approaches have shortcomings, because achieving accurate environmental detection by autonomous vehicles without reliance on specialized environmental sensors is proving to be a difficult, if not impossible, computational task. Also, reliance on connectivity with other computing devices, such as other autonomous vehicles, specialized traffic signals or mobile devices, is expensive, unreliable and poses privacy concerns.

Accordingly, there is a need in the art for an apparatus that improves the detection of objects to autonomous vehicles that does not invade privacy, is not technologically or economically expensive and deployable broadly, including in older vehicles.

### SUMMARY OF THE INVENTION

The present disclosure contemplates apparatuses providing improved detection and identification of objects (e.g. people, pets, bicycles or vehicles), by devices, such as autonomous vehicles, that rely on reflective sensors, such as lidar, for understanding their surrounding environment. The present disclosure contemplates objects having integrated or embedded materials of a predetermined shape or pattern that is readily detectable and identified by systems using non-visual detection systems (e.g. lidar, radar, or microwave), such as autonomous vehicles, even in challenging weather and visibility conditions. The predetermined shape or pattern allows the lidar system to recognize and identify the type of object. In embodiments, the integrated material allows the sensors to determine the orientation of the object.

Embodiments described in the present disclosure include wearable objects that are embedded with aluminum or other metallic material having a specific pattern or shape to identify the person or thing wearing the wearable object. In embodiments, the embedded metallic materials are not visible to people, but are detectable by lidar or other sensor systems.

Other embodiments described in the present disclosure include road markings, such as road paint and signage, embedded with aluminum or other metallic material of a predetermined pattern to assist sensors, such as lidar, to quickly detect and identify the meaning of such markings. Other transportation infrastructure, such as bridges, tunnels, landmarks, exits, destinations, shops, gas stations, services, signage and barriers may also be embedded with unique patterns. Other embodiments described in the present disclosure include objects that may be applied to vehicles or bicycles to improve the detectability of vehicles or bicycles, or the specific components of vehicles or bicycles, by sensors such as lidar.

### BRIEF DESCRIPTION OF THE FIGURES

FIG. 1 is a block diagram illustrating a scanning system that can be used in accordance with embodiments of the present invention.

FIG. 2 illustrates a human wearing clothing according to embodiments described herein.

FIG. 3 is a flow diagram illustrating a method for scanning and detecting objects in accordance with embodiments of the present invention.

FIG. 4 is a flow diagram illustrating a method for scanning and detecting objects in accordance with embodiments of the present invention.

FIG. 5 illustrates a road according to embodiments described herein.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purposes of clarity, details relating to technical material that is known in the technical fields related to the invention have not been described in detail so as not to unnecessarily obscure the present invention.

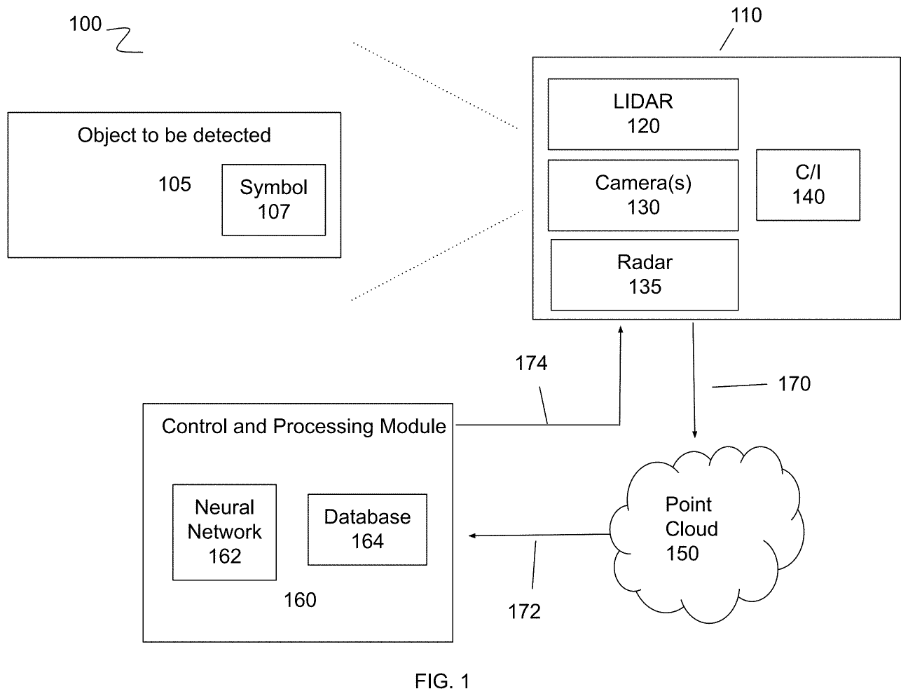

FIG. 1 shows an exemplary LIDAR scanning system 100. Scanning system 100 utilizes a field digital vision (FDV) module 110 that includes a scanning device for scanning a target object 105, such as a vehicle, pedestrian, bicycle or road marking. The scanning device senses the position in three-dimensional space of selected points on the surface of the object 105. Based upon the light or RF reflected back by the surface of the object 105, the FDV module 110 generates a point cloud 150 that represents the detected positions of the selected points. The point cloud 150 can also represent other attributes of the detected positions, such as reflectivity, surface color, and texture, where desired.

A control and processing module 160 interacts with the FDV 110 to provide control and targeting functions for the scanning sensor. In addition, the control and processing module 160 can utilize a neural network 162 comprised of software to analyze groups of points in the point cloud 150 to identify the category of object of interest 105 and generate a model of the object of interest 105 that is stored in a database 164. The processing and control module 160 can have computer code in resident memory, on a local hard drive or in a removable drive or other memory device, which can be programmed to the processing module 160 or obtained from a computer program product such as a CD-ROM or download signal.

The FDV 110 can include an optical transceiver, shown in FIG. 1 as a LIDAR scanner 120, that is capable of scanning points of the target object 105, and that generates a data signal that precisely represents the position in 3D space of each scanned point. The data signals for the groups of scanned points can collectively constitute the point cloud 150. In addition, a video system 130 can be provided, which in one embodiment includes both wide angle and narrow angle CCD cameras. The wide angle CCD camera can acquire a video image of the object 105 and provides to the control and processing module 160, through a control/interface (C/I) module 140, a signal that represents the acquired video image. The FDV 110 can also include a radar transceiver 135 that is capable of scanning points of the target object 105 using radio waves. In combination, the LIDAR 120, video system 130 and radar 135 can be used to generate a highly detailed image of the environmental objects 105 to be scanned.

Conventional LIDAR scanning systems generate distance information based upon time-related measurements of the output from a single wavelength laser. If any color information on the scanned object or scene is required, it is typically obtained using a second conventional, non-time resolved camera, as discussed above with respect to the FIG. 1 system 100. The auxiliary camera may be mounted in parallel (alongside, laterally displaced) with the LIDAR system or coaxially by the use of either a beam-splitter or a separate moving mirror to intermittently intercept the LIDAR optical path. The two sets of data images, the LIDAR data and conventional camera data, may further be combined using so-called “texture mapping” in which the non-time resolved color information obtained from the conventional camera data is superimposed upon the LIDAR data using dedicated software, so as to produce a pseudo “color LLDAR” image.

In embodiments, object 105 includes a symbol 107 that is embedded in object 105. In embodiments, symbol 107 is comprised of a material that is more readily detected by LIDAR 120, such as aluminum or other metallic material that are known to be reflective of laser sources. In embodiments, symbol 107 has a shape or pattern that is unique to the category of object 105 in which it is embedded. For example, a unique symbol or pattern may be ascribed to a person, whereas a separate unique symbol or pattern may be ascribed to a bicycle. In embodiments, symbol 107 is embedded in a way that is not visible to people but is detectable by LIDAR 120. For example, the symbol 107 may be a pattern embedded into a person's clothing in a discrete way, such as by use of thin threads composing the symbol 107 or placing the symbol 107 in the clothing of a person in a non-visible location, such as the interior of a pocket.

In embodiments, object 105 may include more than one symbol 107. In embodiments, a first symbol 107 may be of a shape or pattern that designates both the category of object 105 and the orientation of object 105. For example, in embodiments where object 105 is a human wearing clothing embedded with a symbol 107, symbol 107 may have a shape or pattern that identifies object 105 as a human. Symbol 107 that is located on the front side of the person's clothing may have an additional shape or pattern identifying that it is located on the front of the object 105. A second symbol may also be embedded in the person's clothing on the back side with a separate shape or pattern identifying that it is located on the back side of object 105. In this way, the orientation and direction of object 105 may be more readily detected, for example, in conditions where it may be difficult to distinguish which way an object 105 is facing. This may be useful in predicting whether the object 105 may move in a particular direction. It is understood that the embodiments system described in FIG. 1 is applicable to other detection systems, such as radar or microwave systems.

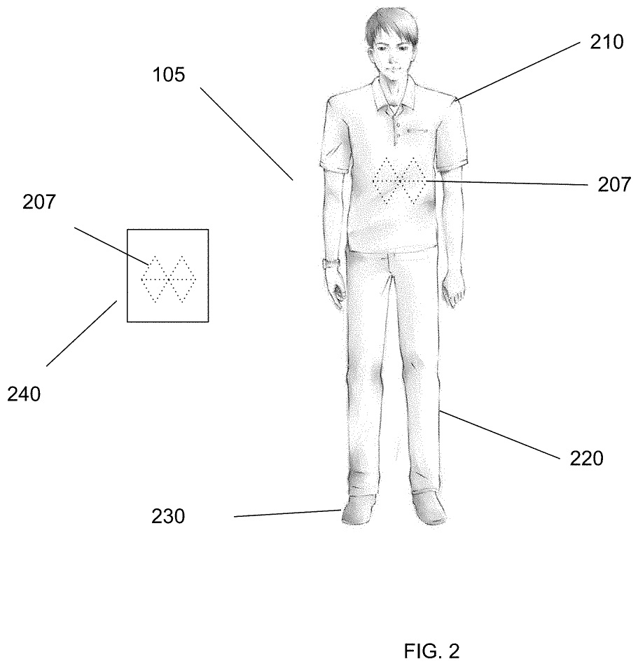

FIG. 2 is a figure showing an example of object 105 in the form of a human 205. The human 205 is wearing clothing, including a shirt 210, pants 220 and shoes 230. In the embodiment shown in FIG. 2, embedded within the shirt 210 is a pattern 207 that is an embodiment of pattern 107 shown in FIG. 1. In the embodiment shown in FIG. 2, pattern 207 is a double-diamond pattern, though it is understood that the pattern 207 may be any predetermined shape or pattern associated with a human 205. In embodiments, the pattern 207 includes a complex authentication component, such as a non-public pattern that is not easily replicated, to avoid forgeries. In embodiments, pattern 207 may be embedded in one or more of the shirt 210, pants 220 or shoes 230 or other wearable objects of the human object 205. In embodiments, the pattern 207 is integrated into the shirt 210, pants 220 or shoes 230 in a way that is not visible. In embodiments, the pattern 207 is made of a material that is known to be easily detectable by scanning systems, such as LIDAR. For example, the pattern 207 is created using aluminum or other materials known to be reflective of laser sources. In embodiments, the pattern 207 is multidirectional, having specific topological characteristics (e.g. bumpiness and angularity) to define the pattern.

In embodiments, a second symbol is embedded on the backside of human object 205. In embodiments, the pattern 207 located on the front of human object is different from the symbol located on the back of human object 205 to allow for detection of the orientation of the human object 205. For example, as shown in FIG. 2, the front side of the person's shirt 210 includes a double-diamond pattern 207 where the two diamonds are arranged horizontally with respect to each other. The back side of the person's shirt 210 may have a double-diamond pattern where the diamonds are arranged differently, such as vertically with respect to each other, to indicate that it is the backside of a human as opposed to the front side of a human 205. In embodiments, a stand-alone object 240 having the embedded symbol 207 is attachable to the person, garment or accessories, or may be placed in the pocket of a garment or accessory.

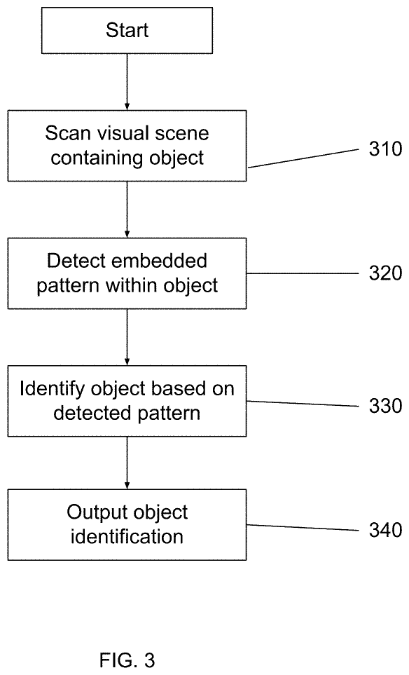

FIG. 3 is a flow diagram illustrating a method for identifying an object using a scanning system, such as LIDAR, according to one embodiment described herein. As shown, the method begins at block 310, where the scanning system 110 scans a visual scene (e.g. using one or more devices, such as LIDAR 120, camera 130 or radar 135) containing an object 105. In block 320, the control and processing module 160 then detects the presence of a predefined embedded symbol 107 or pattern within object 105. In block 330, the detected symbol 107 or pattern is used, in part, to identify the object 105 in which the symbol 107 is embedded. For example, database 164 may be configured to store data that correlates a set of predetermined patterns to specified objects. For instance, an embedded double-diamond pattern could be predefined to represent the front side of a human. When the predefined symbol or pattern is detected, for example, in a person's clothing, the control and processing module 160 determines that the object is a human. The detection 330 may be made in conjunction with other object detection methods, such as detection and analysis of the boundaries of the object 105 using conventional means. In block 340, the object identification is outputted, for example to the neural network 162 for use in understanding and responding to the environment in which the object appears.

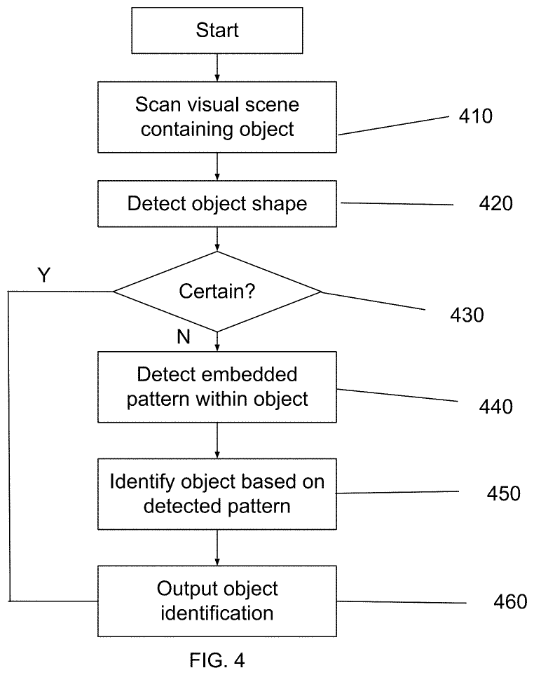

FIG. 4 is a flow diagram illustrating a method for identifying an object using a scanning system, such as LIDAR, according to one embodiment described herein. As shown, the method begins at block 410, where the scanning system 110 scans a visual scene (e.g. using one or more devices, such as LIDAR 120, camera 130 or radar 135) containing an object 105. In block 420, the control and processing module 160 then detects the shape of the object 105 and based on that shape, determines what the object 105 is, such as vehicle, person, sign. In block 430, the system determines the certainty of the object determination 420. If the certainty in the object identification is above a certain threshold of certainty (e.g. 99%) as to the accurate detection of the object 105, the object identification is outputted 460. If the certainty in the object identification does not reach a sufficient certainty threshold, in block 440, the control and processing module 160 detects the presence of a predefined embedded symbol 107 or pattern within object 105. In block 450, the detected symbol 107 or pattern is used, in part, to identify the object 105 in which the symbol 107 is embedded. For example, database 164 may be configured to store data that correlates a set of predetermined patterns to specified objects. For instance, an embedded double-diamond pattern could be predefined to represent the front side of a human. When the predefined symbol or pattern is detected, for example, in a person's clothing, the control and processing module 160 determines that the object is a human. In block 460, the object identification is outputted, for example to the neural network 162 for use in understanding and responding to the environment in which the object appears.

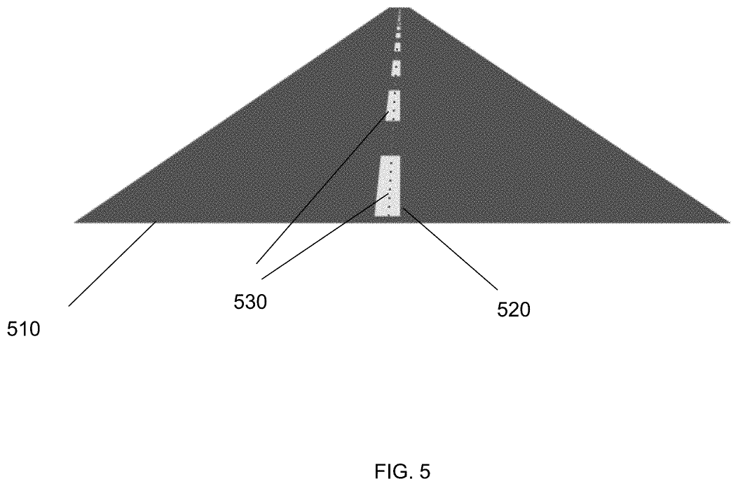

FIG. 5 shows a road 510 having traditional lane markings 520. In embodiments, the lane markings 520 include a pattern 530 down the center made of a material, such as aluminum or other metallic material, to improve detection by a scanning system, such as LIDAR. The pattern 530 may be placed anywhere in or around the lane markings 520. The pattern 530 may be embedded in the paint of the lane markings 520 as speckles or spots. Other patterns may be places in the road to signify other road markings, such as cross walks, intersections, rail crossings, school zones, for example. The pattern 530 improves the detection of the road markings by including a material that is more easily detectable by a scanning system such as LLDAR to improve the object recognition of the LIDAR system in conditions where visibility is challenged. Similar patterns or symbols may be embedded in road signs or traffic signals.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. An apparatus detectable by a detection system, comprising:
an article of clothing wearable by a person;
embedded within said article of clothing, a three-dimensional pattern comprised of metallic material;
wherein said pattern is not visible; and
wherein said pattern has a predefined association with said detection system that said apparatus is wearable by a person.

2. The apparatus claimed in claim 1, wherein said pattern is comprised of aluminum.

3. The apparatus claimed in claim 1, further comprising:
wherein said pattern has a further predefined association that said pattern is located in the front of said article of clothing.

4. The apparatus in claim 3, further comprising:
embedded within said article of clothing, a second pattern comprised of a metallic material;
wherein said second pattern is not visible;
wherein said second pattern has a predefined association that said article of clothing is wearable by a person; and
wherein said second pattern is further has a further predefined association that said second pattern is located in the back of said article of clothing.

5. A method of detecting an first object in an environment, said object having an embedded pattern comprised of metallic material, comprising the steps of:
scanning said environment using a LIDAR scanner;
detecting, in the environment, said pattern;
identifying a second object based on a predefined association with said first object and said second object and a predefined association between said pattern and said second object;
outputting said identification to generate a virtual image of said environment.

6. The method of claim 5, further comprising the steps of: identifying the orientation of said second object based on said detection of said pattern.

7. An apparatus comprising:
a pattern comprised of a metallic material;
said pattern embedded within said apparatus so as to be invisible;
wherein said pattern has a predefined association identifying said apparatus.

8. An apparatus as claimed in claim 7, wherein said pattern further has a predefined association identifying the orientation of said apparatus.

9. An apparatus as claimed in claim 7, wherein said pattern is comprised of aluminum.

10. An apparatus as claimed in claim 7, wherein said apparatus is wearable by a person.

11. An apparatus as claimed in claim 7, wherein said apparatus is road paint.

12. An apparatus as claimed in claim 7, wherein said apparatus is attachable to a vehicle.

13. An apparatus as claimed in claim 7, wherein said apparatus is attachable to a bicycle.
